(19) United States
(12) Patent Application Publication
(10) Pub. No.: US 2001/0030786 A1
(43) Pub. Date: Oct. 18, 2001

(54) Optical add/drop multiplexer apparatus, method of controlling the same and optical communication system

(75) Inventors: Kenichiro Takahashi, Kanagawa (JP); Tomomi Sano, Kanagawa (JP); Hiroshi Suganuma, Kanagawa (JP)

Correspondence Address: McDERMOTT, WILL & EMERY, 600 13th Street, N.W., Washington, DC, 20005-3096, US

(73) Assignee: SUMITOMO ELECTRIC INDUSTRIES, LTD.

(21) Appl. No.: 09/832,947

(22) Filed: Apr. 12, 2001

(30) Foreign Application Priority Data
Apr. 12, 2000 (JP) 2000-110793

(51) Int. Cl. H04J 14/02

(52) U.S. Cl. 359/127; 359/130

(57) ABSTRACT

In the OADM apparatus incorporates a reflecting filter having a tunable mechanism, part of an added or dropped signal light is branched and extracted as a monitor light, and the monitor light is further branched into two lights. One of the two lights after branching is passed through an optical filter having wavelength dependency. The monitor light that has passed through the optical filter and the other monitor light that has not passed through the optical filter are guided to detectors of a detection circuit. The ratio of optical power of the two monitor lights is obtained, and the tunable mechanism is controlled so that the value of the ratio may be a predetermined value.

### BACKGROUND OF THE INVENTION

1. Field of the Invention

The present invention relates to an optical add/drop multiplexer apparatus (hereinafter referred to as OADM apparatus) used for a wavelength division multiplexing (WDM) optical communication system, which drops or adds a signal light having a channel assigned to a specific wavelength from or to a wavelength-division-multiplexed signal light (hereinafter referred to as WDM signal light) having a plurality of channels respectively assigned to independent and appropriately spaced wavelengths. The present invention also relates to a method of controlling the OADM apparatus and a WDM optical communication system using the OADM apparatus.

2. Description of the Related Art

The optical communication using single-mode type silica optical fibers is characterized by large-capacity transmission. The WDM optical communication system, which uses wavelengths in the proximity of a wavelength of 1.55 micrometer that is the lowest loss wavelength region in the single-mode type optical fiber, has been put to practical use as a technology using the advantage of the large-capacity transmission.

As the WDM optical communication system has a network configuration where a number of points are interconnected in a mesh, instead of transmission between specific two points, it becomes necessary to drop or add a signal light having a channel assigned to a specific wavelength at a network node. The particular configuration of OADM apparatus having such features is described in for example in H. Kanamori “Fiber Grating” (‘Kogaku Gijutsu Kontakuto’ optical technology contact, Vol. 35, No. 6, PP. 343-348, 1997).

The principle of OADM apparatus described in the aforementioned document is shown in FIG. 5. In FIG. 5, a WDM signal light having a plurality of channels, each of which is assigned to a specific wavelength, is transmitted from an optical fiber end 53a of an optical fiber 53 to an optical fiber end 54a of an optical fiber 54. The OADM apparatus comprises optical circulators 51, 52, a fiber grating section 55 with a cyclic refractive-index type grating 56 formed along the core, an optical fiber 57 for dropping signal light connected to the optical circulator 51, and an optical fiber 58 for adding signal light connected to the optical circulator 52.

The operation principle of OADM apparatus in FIG. 5 will be detailed below. It is assumed that the cyclic refractive-index type grating 56 formed on the fiber grating section 55 has a characteristic of reflecting only a signal light having a channel assigned to a specific wavelength A k among the WDM signal light. Assuming that WDM signal light incident from the optical fiber end 53a of the optical fiber 53 contains signal lights having channels respectively assigned to wavelengths from λ1 to λn, only the signal light having the channel assigned to the wavelength of λk is reflected on the cyclic refractive-index type grating 56 of the fiber grating section 55 and is output (dropped) to the optical fiber end 57a via the optical circulator 51.

According to a similar principle, a signal light having the channel assigned to the wavelength of λk incident (added) from the optical fiber end 58a of the optical fiber 58 is reflected on the cyclic refractive-index type grating 56 of the fiber grating section 55 and is output to the optical fiber end 54a of the optical fiber 54 via the optical circulator 52. That is, the OADM apparatus composed of two optical circulators 51, 52 and the fiber grating section 55 has a feature to add/drop an optical signal having a channel assigned to a wavelength of λk corresponding to the grating spacing of the cyclic refractive-index type grating 56 formed on the fiber grating section 55.

Since it is not desirable that a reflected wavelength of the cyclic refractive-index type grating 56 varies with a variation in the ambient temperature and it is known that the reflected wavelength of the fiber grating itself has the temperature dependency of 0.01 nm/° C., the fiber grating section is typically housed in a temperature compensated package or temperature independent package so that the characteristics of the fiber grating section 55 may not be affected even when the ambient temperature is changed. Use of a temperature compensated package may reduce the temperature dependency of the fiber grating down to around 0.001 nm/° C. However, such temperature compensation characteristics are not sufficient, when the interval between adjacent channels in the WDM optical communication system becomes narrower than present state, where the value is around 0.8 nm.

In case a variation in an optical network takes place in accordance with a constant increase in the communication traffic, the transmission route of the optical network is re-designed, so that it may be necessary to change the channel of an added/dropped signal light or the number of channels of the added/dropped signal lights at a specific node. In such a case, the OADM apparatus needs to have the add/drop feature of signal lights having different channels respectively assigned to different wavelengths, and it is preferable to provide the fiber grating with a tunable reflected wavelength.

Since the reflected wavelength of the fiber grating is specified by the grating spacing of the cyclic refractive-index type grating formed along the core, the reflected wavelength can be varied by applying tension in the longitudinal direction of the fiber grating to vary the grating spacing of the cyclic refractive-index type grating. In A. Iocco et. al., “Bragg grating fast tunable filter” (ELECTRONICS LETTERS Vol. 33, No. 25, December 1997) discloses a technology in order to vary the reflected wavelength. In the technology, a piezoelectric actuator is stretched/compressed by applying a DC voltage across the piezoelectric actuator, and the grating spacing of the cyclic refractive-index type grating formed along the core is varied by the tension/compression of the piezoelectric actuator, so that the reflected wavelength of the fiber grating can be varied.

FIG. 6 shows the relationship between the piezoelectric actuator displacement and the wavelength shift, as shown in the document. It is shown that a variation of some 15 nm in the wavelength is possible. In case the feature for varying the reflected wavelength is added to the fiber grating, a piezoelectric actuator and the accompanying electric circuits are added to OADM apparatus. This makes the apparatus complicated, and makes the high-accuracy temperature compensation difficult. As a result, the OADM apparatus cannot achieve to stabilize the reflected wavelength of a reflecting filter including the fiber grating as a component of the OADM apparatus. Meanwhile, as the interval between adjacent communication channels becomes narrower in order to provide a large-capacity WDM optical communication system, requirements for stable characteristics of the reflecting filter as a component of the OADM apparatus become more difficult to achieve.

### SUMMARY OF THE INVENTION

It is an object of the invention to provide an optical add/drop multiplexer apparatus as an essential component for implementing a WDM optical communication system, especially, the optical add/drop multiplexer apparatus which selects channels of the reflected wavelength of a fiber grating and stabilizes an add/drop wavelength thereof, i.e., the reflected wavelength. It is another object of the invention to provide a method of controlling the OADM apparatus and a wavelength division multiplexing optical communication system using the OADM apparatus, which selects channels of the reflected wavelength of the fiber grating and stabilizes an add/drop wavelength thereof. The OADM apparatus corrects the add/drop wavelength thereof, that is, a reflected wavelength of a fiber grating as a component of the OADM apparatus, to be a preset wavelength, in case the add/drop wavelength has changed via a variation in the ambient temperature.

An OADM apparatus having a reflecting filter with a tunable mechanism, according to the invention, has a stable characteristics wherein the wavelength of the reflected light at reflecting filter is not changed via variation in the ambient temperature. In the OADM apparatus, a part of an added or dropped signal light as a monitor light is branched and extracted, the monitor light is further branched into two lights, and one of the two lights after branching is passed through an optical filter having a wavelength dependency. The monitor light that has passed through the optical filter and the other monitor light that has not passed through the optical filter are guided to detectors of a detection unit, and a ratio of optical power of the two monitor lights is obtained in the detection unit. The reflection spectrum characteristics of the reflecting filter is stabilized by controlling the tunable mechanism so that the value of the ratio may be a predetermined value.

### BRIEF DESCRIPTION OF THE DRAWINGS

FIG. 1 shows a configuration of an OADM apparatus according to the first embodiment of the invention;

FIG. 2A shows a characteristics of an optical filter;

FIG. 2B shows a variation amount of a reflected wavelength of a fiber grating and the ratio of the optical power detected by detector 1 to the optical power detected by detector 2 in case the optical filter as shown in FIG. 2A is used;

FIG. 3A shows a characteristics of an another optical filter;

FIG. 3B shows a variation amount of a reflected wavelength of a fiber grating and the ratio of the optical power detected by detector 1 to the optical power detected by detector 2 in case the optical filter as shown in FIG. 3A is used;

FIG. 4 shows a configuration of an OADM apparatus according to the second embodiment of the invention;

FIG. 5 shows the principle of OADM apparatus according to related art; and

FIG. 6 shows the relationship between the piezoelectric actuator displacement and the wavelength shift.

### DETAILED DESCRIPTION OF THE PREFERRED EMBODIMENT

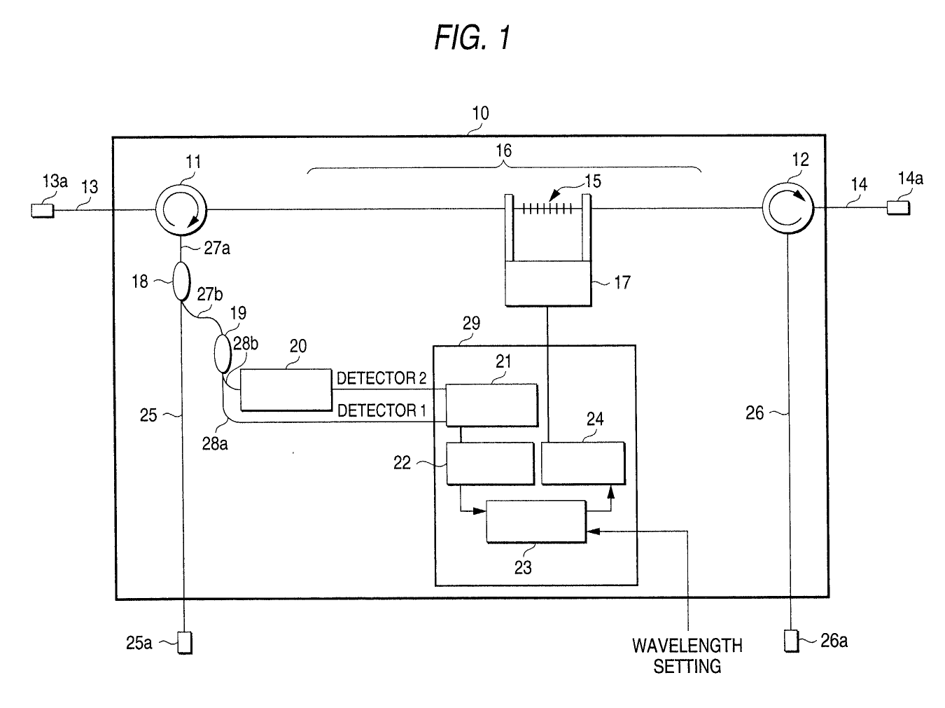

FIG. 1 shows the first embodiment of an OADM apparatus according to the invention. The OADM apparatus comprises optical circulators 11, 12, optical fibers 13,14, a fiber grating section 16, couplers 18,19, an optical filter 20, an optical fiber 25 for dropping signal light, an optical fiber 26 for adding signal light, and a controller 29. The optical fiber 13 has an optical fiber end 13a at the end, and the optical fiber 14 has an optical fiber end 14a at the end. The fiber grating section 16 has a cyclic refractive-index type grating formed along the core. The half width of a reflection spectrum of the fiber grating section 16 is typically 0.2 nm. The optical fiber 25 has an optical fiber end 25a at the end, and the optical fiber 26 has an optical fiber end 26a at the end. The optical circulator 11 guides the WDM signal light incident from the optical fiber end 13a of the optical fiber 13 to the fiber grating section 16. A signal light having a channel assigned to a specific wavelength is reflected on the cyclic refractive-index type grating 15, and is output to an optical fiber 27a via the optical circulator 11. That is, it is possible to drop the signal light having the channel assigned to the specific wavelength from the optical fiber end 25a of the optical fiber 25.

The intermediate part of the fiber grating section 16 where the cyclic refractive-index type grating 15 is formed is fixed to a tunable mechanism 17. As an example, the tunable mechanism 17 is composed of a piezoelectric actuator. The piezoelectric actuator is stretched/compressed by applying a predetermined DC voltage, and the part, where the cyclic refractive-index type grating 15 of the fiber grating section 16 mechanically coupled to the piezoelectric actuator is formed, is stretched and compressed by the tension/compression of the piezoelectric actuator. As a result, the grating spacing of the cyclic refractive-index type grating is changed. This function enables to select a channel assigned to the specific wavelength reflected at the fiber grating section 16.

The optical coupler 18, acting as an optical branching device, branches a part of signal light from the optical fiber 27a and leads the branched light as a monitor light to an optical fiber 27b. It is necessary that the monitor light branched by the optical coupler 18 to the optical fiber 27b does not substantially reduce the power of the dropped signal light extracted from the optical fiber end 25a. Preferably optical power of 20 dB (1 percent) or below of the signal light is branched as a monitor light to the optical fiber 27b.

The optical coupler 19 further branches the monitor light branched by the optical coupler 18. The ratio of branching is preferably about 1:1 considering the division process mentioned later. Monitor lights branched by the ratio of 1:1 by the optical coupler 19 enter optical fibers 28a and 28b.

The optical fiber 28b is connected to an optical filter 20. The optical filter 20 has mild loss dependence of transmission spectrum characteristics. As an example, the optical filter 20 can be composed using a long period grating.

The monitor light that has entered the optical fiber 28b and passed through the optical filter 20 enters detector 2 of a photo-detection circuit 21 as a component of the controller 29. On the other hand, the monitor light that has entered the optical fiber 28a enters detector 1 of the photo-detection circuit 21 without passing through the optical filter 20. An analog electric signal corresponding to the optical power of the monitor light detected by the photo-detection circuit is input to a microcomputer 23 via an A/D converter 22. The microcomputer 23 obtains the power ratio of the monitor light that has passed through the optical fiber 28a to the monitor light that has passed though the optical fiber 28b and the optical filter 20.

Because the reflection spectrum characteristics of the fiber grating section 16 is affected by a variation in the grating spacing of the cyclic refractive-index type grating 15 of the fiber grating section 16 due to the ambient temperature change, a signal light reflected on the cyclic refractive-index type grating 15 of the fiber grating section 16 suffers from variation in terms of center wavelength and optical power thereof, even if the spectrum of a signal light incident from the fiber end 13a is stable.

The variation in the reflection spectrum characteristics of the cyclic refractive-index type grating 15 of the fiber grating section 16 due to the ambient temperature change between 0 to 70° C. is about 0.7 nm on a calculation basis. The optical coupler 18 has characteristics of substantially showing no wavelength dependency on a variation in the spectrum of the signal light. Thus, the monitor light incident on the optical coupler 19 via the optical fiber 27b has the same wavelength spectrum as that of the signal light detected at the optical fiber end 25a. That is, the monitor light incident on the optical coupler 19 via the optical fiber 27b carries out a high-fidelity monitoring of the spectrum of the signal light at the fiber end 25a.

The optical coupler 19 also has characteristics of substantially showing no wavelength dependency on a variation in the spectrum of the signal light or monitor light. Thus, the monitor lights incident on the optical fibers 28a, 28b from the optical coupler 19 have the same spectrum. The condition that each of the optical couplers 18, 19 does not have the wavelength dependency in the wavelength range of the monitor light can be easily satisfied by using a typical 1.5-μm band wavelength independent fusion-type optical fiber coupler.

As mentioned earlier, signal lights detected by detector 1 and detector 2 of the photo-detection circuit 21 individually undergoes A/D conversion via the A/D converter 22 of the controller 29, then division of the signal lights detected by detector 1 and detector 2 is made via the microcomputer 23 in order to obtain the ratio of the optical power detected by detector 1 to the optical power detected by detector 2. In this practice, the percentage of the monitor light that suffers from attenuation via the optical filter 20 depends on the spectrum of the monitor light. Thus, in case the reflection spectrum characteristics of the fiber grating section 16 is affected, a variation occurs in the ratio of the optical power detected by detector 1 to the optical power detected by detector 2. Accordingly, it is possible to detect the variation amount of the reflection spectrum characteristics of the fiber grating section 16, by grasping the aforementioned relationship.

In the case that the spectrum of the signal light incident from the fiber end 13a is changed, the optical power of the monitor light that has passed through the optical filter 20 varies with a variation of the wavelength of the monitor light due to the ambient temperature change and the variation of the spectrum of the incident signal light. The optical power of the monitor light that has not pass through the optical filter 20 also varies due to the variation of the spectrum of the incident signal light. As mentioned above, since the microcomputer 23 obtains the ratio of the optical power detected by the detector 1 to the optical power detected by the detector 2, it is possible to stably obtain the variation amount of the reflection spectrum characteristics of the fiber grating section 16 regardless of the variation of the spectrum of the incident signal light.

In accordance with the variation amount of the wavelength detected as mentioned earlier, the microcomputer 23 outputs a control signal for the tunable mechanism 17 via a D/A converter 24. The control signal appears as a voltage or current depending on the type of actuator constituting the tunable mechanism 17 mentioned later.

In OADM apparatus, in case the setting of the channel of the reflected wavelength is changed, the monitor of the reflected wavelength as mentioned above is suspended, while a predetermined control signal is applied, then the monitor of the reflected wavelength starts again.

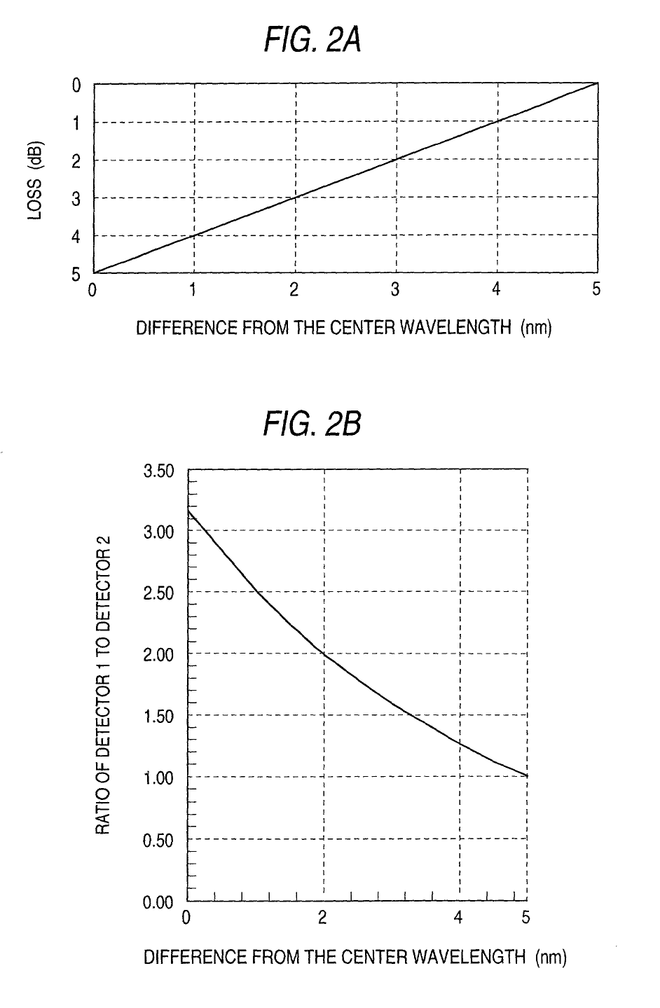

FIG. 2A displays an example of characteristics of an optical filter that implements OADM apparatus according to the invention. The optical filter shown in FIG. 2A has a linear attenuation characteristic of 5 dB higher at the center wavelength relative to a wavelength 5 nm apart from the center wavelength. Here, the center wavelength is a reference wavelength determined from the operating wavelength range of the signal light, and the difference from the center wavelength means difference from the reference wavelength.

FIG. 2B shows the ratio of the optical power detected by detector 1 to the optical power detected by detector 2 obtained in case a monitor light has entered the optical filter having such wavelength characteristics as shown in FIG. 2A. In FIG. 2B, the horizontal axis represents the difference from the center wavelength of the optical filter. The vertical axis represents the ratio of the optical power detected by detector 1 against the optical power detected by detector 2.

As shown in FIG. 2A, it is understood that a variation in the wavelength of the monitor light passing through the optical filter 20 causes a variation in the ratio of the optical power of the monitor light that has not passed through the optical filter 20 detected by detector 1 against the optical power of the monitor light that has passed through said optical filter 20 detected by detector 2, because attenuation of the monitor light varies with the use of the optical filter 20. In FIG. 2B, while the calculation assumes the branching ratio of the optical coupler 19 as 1:1, the branching ratio of the optical coupler 19 is by no means limited to 1:1.

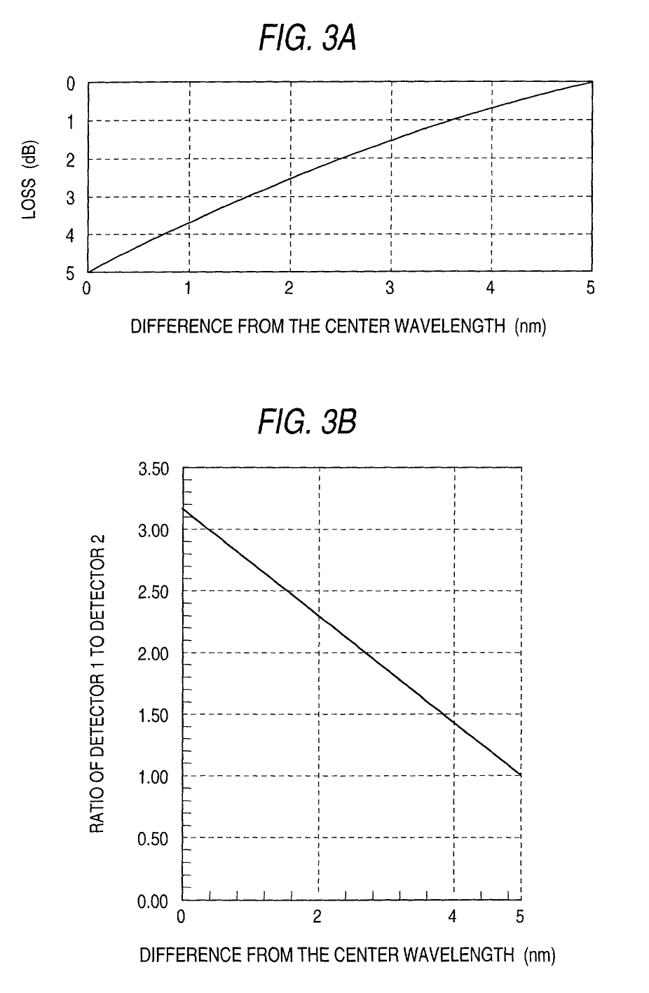

FIG. 3A displays an example of characteristics of an another optical filter that implements OADM apparatus according to the invention. The optical filter in FIG. 3A has characteristics that attenuation of the monitor light varies nonlinearly with respect to the difference between the center wavelength and the wavelength of the monitor light. FIG. 3B shows the ratio of the optical power detected by detector 1 to the optical power detected by detector 2 obtained in case a monitor light has entered the optical filter having such a wavelength characteristics. As shown in FIG. 3B, the ratio of the optical power detected by detector 1 to the optical power detected by detector 2 varies linearly with respect to the difference between the central wavelength and the wavelength of the monitor light. Accordingly, if the optical filter having the characteristics as shown in FIG. 3A is used, it is possible to perform constant control of the tunable mechanism regardless of the difference from the center wavelength, and reduce the load to the control system.

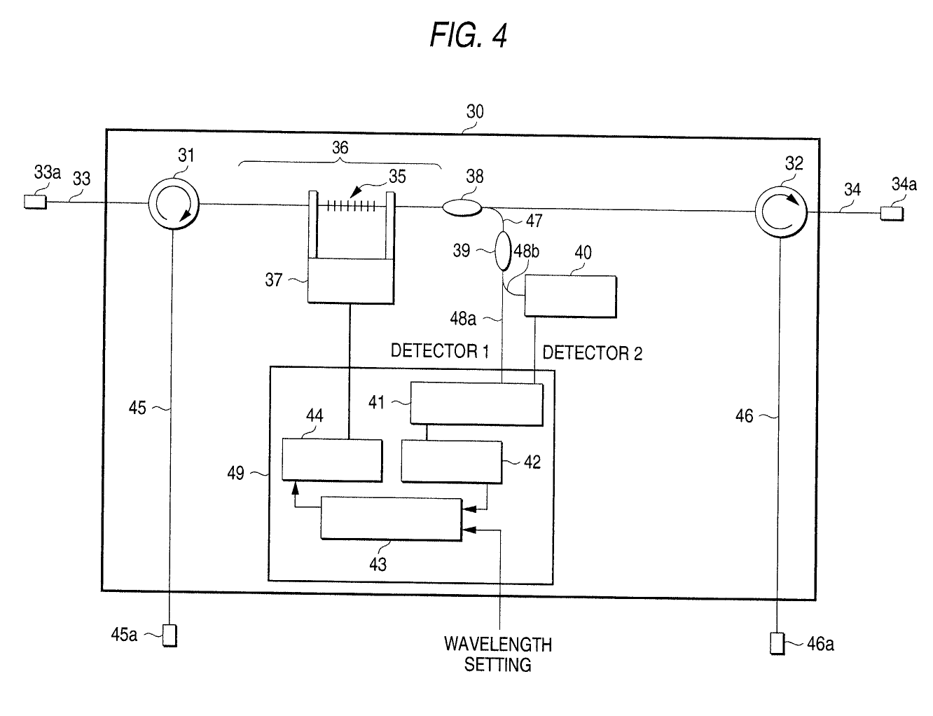

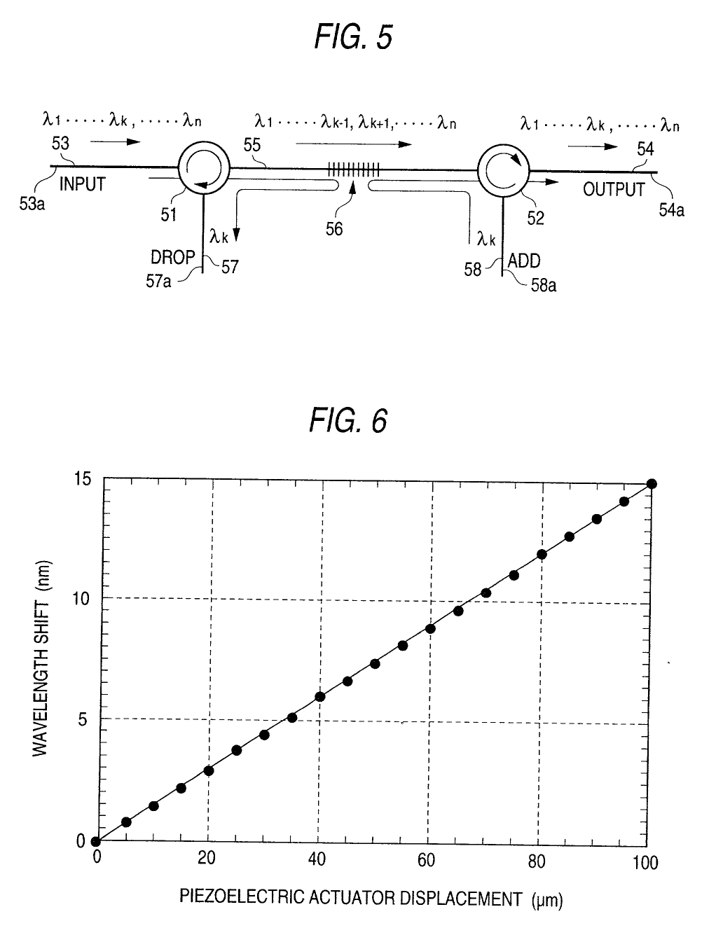

FIG. 4 is another embodiment of the invention for monitoring a signal light incident on an optical fiber for signal input 26 from an optical fiber 26a in FIG. 1. In FIG. 4, the same effect as in FIG. 1 is obtained by monitoring variations in the reflection spectrum of a signal light incident from an optical fiber end 46a to a cyclic refractive-index type grating 35. In FIG. 4, 30 represents OADM apparatus, 31, 32 optical circulators, 33, 34 optical fibers, 36 a fiber grating section, a tunable mechanism, 38, 39 optical couplers, 40 an optical filter, 41 a photo-detection circuit, 47, 48a, 48b optical fibers, 42 an A/D converter, 43 a microcomputer, 44 a D/A converter, 45 an optical fiber for dropping signal light, 46 an optical fiber for adding signal light, and 49 a controller. Operation principle is the same as that of OADM apparatus shown in FIG. 1. A signal light having a channel assigned to a specific wavelength is added from the optical fiber end 46a and reflected on the cyclic refractive-index type grating 35 of the fiber grating section 36, and is output to the optical fiber 34 via the optical circulator 32. The optical coupler 38 as an optical branching device, which is disposed between the fiber grating section 36 and the circulator 32, branches a part of signal light reflected from the fiber grating section 36 and leads the branched light as a monitor light to the optical fiber 47. The optical coupler 39 further branches the monitor light branched by the optical coupler 38, and monitor lights branched by the optical coupler 39 enter optical fibers 48a and 48b. The monitor light that has entered the optical fiber 48b passes through the optical filter 40 and enters detector 2 of the photo-detection circuit 41. On the other hand, the monitor light that has entered the optical fiber 48a enters detector 1 of the photo-detection circuit 41 without passing through the optical filter 40. The microcomputer 43 obtains the ratio of the monitor light that has passed through the optical fiber 48a to the monitor light that has passed though the optical fiber 48b and the optical filter 40.

Reflection spectrum characteristics of the cyclic refractive-index type gratings 15, 35 formed along the core of the fiber grating are typically non-directional. Thus the effects are the same between the monitoring method in FIG. 1 and that in FIG. 4. Either method may be used to control the tunable mechanism 17, 37. In case the reflection spectrum characteristics of the cyclic refractive-index type gratings 15, 35 are directional, the monitoring methods in FIGS. 1 and 4 are preferably used together in order to control tunable mechanisms 17, 37 respectively.

The tunable mechanisms 17, 37 maybe composed of any means for varying the grating spacing of the cyclic refractive-index type gratings 15, 35 of the fiber grating sections 16, 36. Since the transient variation of the reflected wavelengths on the cyclic refractive-index type gratings 15, 35 is caused by a variation in the ambient temperature of the fiber grating, i.e., a variation in the grating spacing of the cyclic refractive-index type gratings 15, 35 or a variation of refractive index of the glass. Therefore, high-speed response is not necessarily required of the tunable mechanisms 17, 37. Accordingly, means for adding a stress for stretching/compressing fiber grating sections 16, 36 is not limited to a piezoelectric actuator. It may be an electromagnetic actuator in which a flowing current is controlled and magnitude of the electromagnetic force is varied and variable force is applied on the fiber grating sections 16, 36. Another method may be a heat expansion device with which the ambient temperature is varied by using a heater or a Pertier device to cause thermal expansion or thermal compression on the fiber grating sections 16, 36 thus varying the grating spacing of the cyclic refractive-index type gratings 15, 35 formed along the core of the fiber grating sections 16, 36. Still another method may be also a heating device with which a variation in the refractive index via temperature is changed to control the reflection spectrum.

While fiber grating sections 16, 36 are typically Bragg gratings, chirped gratings with wider reflecting bandwidth may be used to add/drop signal lights of a plurality of channels respectively assigned to different wavelengths via a single node. A dielectric multilayer filter may be used as the optical filters 20, 40. A long period grating is preferable considering compatibility with the optical fibers 28b, 48b.

In case a Bragg grating is used as the fiber grating sections 16, 36 and only an optical signal having a channel assigned to a specific wavelength among WDM optical signal is added or dropped, it may be necessary to change the setting of wavelength of added/dropped signal light at a specific node in accordance with expansion of or modification to optical networks. In the case of a tunable mechanism using a piezoelectric actuator, a wavelength shift of some 15 nm is allowed as shown in FIG. 6. This permits tuning of wavelength in a range sufficiently greater than 0.8 nm as the interval between adjacent channels in the WDM optical communication system, thus satisfying the aforementioned request in the optical networks. In this case, a target value of the ratio of detector 1 to detector 2 can be changed or newly determined, and microcomputers 23, 43 controls tunable mechanisms 17, 37 so that the measured ratio of detector 1 to detector 2 coincides with the target value of the ratio of detector 1 to detector 2.

While the cyclic refractive-index type gratings 15, 35 are used in the above-mentioned embodiments, a dielectric multilayer filter maybe used instead of cyclic refractive-index type gratings 15, 35. In this case, a piezoelectric actuator or electromagnet may be used to apply a mechanical force on a filter, in order to vary the reflection spectrum. In stead, the fiber grating is preferably used to make configuration of the tunable mechanisms simple.

By using the OADM apparatus according to the invention, it is possible to stabilize the add/drop characteristics of the OADM apparatus by correcting the add/drop wavelength of a fiber grating as a component of an OADM apparatus to be a preset wavelength, in case the reflection spectrum characteristics have changed via a variation in the ambient temperature.

The invention provides an OADM apparatus with stable add/drop characteristics free from influences such as a variation in the ambient temperature. The OADM apparatus incorporates a reflecting filter having a tunable mechanism, wherein a reflected wavelength of the reflecting filter is not changed via variation in the ambient temperature in such a manner that a part of an added or dropped signal light is branched and extracted as a monitor light, the monitor light is further branched into two lights, one of the two lights after branching is passed through an optical filter having wavelength dependency, the monitor light that has passed through the optical filter and the other monitor light that has not passed through the optical filter are guided to detectors of a detection circuit, the ratio of optical power of the two monitor lights is obtained, and the tunable mechanism is controlled so that the value of the ratio may be a predetermined value.

According to the invention, the monitor light is branched and the ratio of the monitor light that has passed through the optical filter to the other monitor light that has not passed through the optical filter is obtained to control the tunable mechanism. Thus control is not influenced by a variation in the optical power of detected monitor light that accompanies a variation in the reflection spectrum characteristics of the reflecting filter.

The optical filter 20 in FIG. 1 and the optical filter 40 in FIG. 4 show mild wavelength dependency of the spectrum compared with the fiber grating sections 16, 36. Transmission ratio changes mildly for a variation in the wavelength so that a variation in the characteristics caused by a variation in the ambient temperature is small thus allowing stable control. In particular, temperature dependency assumed in case a long period grating is used is as small as about 0.001 nm/° C., which fits the object of the invention. Though the optical filters 20, 40 do not have tunable mechanisms, it is easy to provide temperature compensated them with packages. As a variation in the transmission ratio to a variation in the wavelength of the optical filters 20, 40 is mild, a variation in the optical power of monitor light detected by the microcomputer becomes smaller compared with the variation in the reflection spectrum of the fiber grating sections 16, 36. The variation in the reflection spectrum of the fiber grating is mainly caused by a variation in the ambient temperature. Thus, high-speed response is not necessarily required of the control process. The high-accuracy control of the tunable mechanism is allowed by adequate time averaging processing in the microcomputer.

What is claimed is:

1. An optical add/drop multiplexer apparatus comprising:
a reflecting filter having a wavelength tunable mechanism, for reflecting a signal light having a predetermined wavelength;
a first optical branch element for branching a part of the signal light reflected at the reflecting filter as a first monitor light; and
a control unit for controlling the wavelength tunable mechanism on the basis of the first monitor light.

2. The optical add/drop multiplexer apparatus according to claim 1, comprising:
a second optical branch element for branching the first monitor light into a second monitor light and a third monitor light;
an optical filter having wavelength dependency, for passing the second monitor light therethrough;
a detection unit for obtaining a ratio of optical power of the second monitor light which has passed through the optical filter to the third monitor light which has not passed through the optical filter,
wherein said control unit controls the wavelength tunable mechanism on the basis of the ratio of the optical power.

3. The optical add/drop multiplexer apparatus according to claim 2, wherein a half width of a transmission spectrum of the optical filter is greater than a half width of a reflection spectrum of the reflecting filter.

4. The optical add/drop multiplexer apparatus according to claim 3, wherein the optical filter has a long period grating.

5. The optical add/drop multiplexer apparatus according to claim 3, wherein said reflecting filter has a Bragg grating or a chirped grating.

6. The optical add/drop multiplexer apparatus according to claim 2, wherein the optical filter has a wavelength dependency that the ratio of the optical power changes linearly with respect to a difference from the center wavelength.

7. A wavelength division multiplexing optical communication system using an optical add/drop multiplexer apparatus, the optical add/drop multiplexer apparatus having:
a reflecting filter having a wavelength tunable mechanism, for reflecting a signal light having a predetermined wavelength;
a first optical branch element for branching a part of the signal light reflected at the reflecting filter as a first monitor light; and
a control unit for controlling the wavelength tunable mechanism on the basis of the first monitor light.

8. The wavelength division multiplexing optical communication system according to claim 7, wherein the optical add/drop multiplexer apparatus having:
a second optical branch element for branching the first monitor light into a second monitor light and a third monitor light;
an optical filter having wavelength dependency, for passing the second monitor light therethrough;
a detection unit for obtaining a ratio of optical power of the second monitor light which has passed through the optical filter to the third monitor light which has not passed through the optical filter,
wherein said control unit controls the wavelength tunable mechanism on the basis of the ratio of the optical power.

9. The wavelength division multiplexing optical communication system to claim 8, wherein a half width of a transmission spectrum of the optical filter is greater than a half width of a reflection spectrum of the reflecting filter.

10. The wavelength division multiplexing optical communication system according to claim 9, wherein the optical filter has a long period grating.

11. The wavelength division multiplexing optical communication system according to claim 9, wherein said reflecting filter has a Bragg grating or a chirped grating.

12. The wavelength division multiplexing optical communication system according to claim 8, wherein the optical filter has a wavelength dependency that the ratio of optical power changes linearly with respect to a difference from the center wavelength.

13. A method of controlling an optical add/drop multiplexer apparatus including a reflecting filter having a wavelength tunable mechanism and an optical filter having wavelength dependency, said method comprising:
branching a part of a signal light reflected at the reflecting filter as a first monitor light;
controlling the wavelength tunable mechanism on the basis of the first monitor light.

14. The method of controlling the optical add/drop multiplexer apparatus according to claim 13, comprising:
branching the first monitor light into a second monitor light and a third monitor light;
passing the second monitor light through the optical filter; and
detecting a ratio of optical power of the second monitor light which has passed through the optical filter and the third monitor light which has not passed through the optical filter,
wherein in controlling step, the wavelength tunable mechanism is controlled on the basis of the ratio of the optical power.

15. The method of controlling the optical add/drop multiplexer apparatus according to claim 14, wherein the optical filter has a wavelength dependency that the ratio of the optical power changes linearly with respect to a difference from the center wavelength.
